(19) United States
(12) Patent Application Publication
(10) Pub. No.: US 2024/0407034 A1
(43) Pub. Date: Dec. 5, 2024

(54) WIRELESS COMMUNICATION METHODS AND SYSTEMS HAVING A FIRST INSTANCE OF INFORMATION ON A SUB-BAND AND A SECOND INSTANCE OF THE INFORMATION ON A DIFFERENT SUB-BAND

(71) Applicant: QUALCOMM Incorporated, San Diego, CA (US)

(72) Inventors: Ahmed ELSHAFIE, San Diego, CA (US); Muhammad Sayed Khairy ABDELGHAFFAR, San Jose, CA (US); Huilin XU, Temecula, CA (US)

(21) Appl. No.: 18/325,493

(22) Filed: May 30, 2023

(51) Int. Cl. H04W 76/20; H04L 5/00

(52) U.S. Cl. CPC H04W 76/20; H04L 5/0051

(57) ABSTRACT

Wireless communications systems, apparatuses, and methods are provided. A method of wireless communication performed by a first wireless communication device includes receiving, from a second network entity, a first instance of information on a first sub-band of a bandwidth part and a second instance of the information on a second sub-band of the bandwidth part, wherein the first instance of the information and the second instance of the information fully overlap in time; and operating in a mode in which the first network entity makes use of the first instance of the information and the second instance of the information.

### TECHNICAL FIELD

This application relates to wireless communication systems, and more particularly, to enhancing wireless communications by repeating information on different sub-bands.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHZ, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing may extend the benefit of NR technologies to operating entities that may not have access to a licensed spectrum.

More recent iterations of wireless communication technologies include NR-Light, enhanced machine type communication (eMTC), and NarrowBand-Internet of Things (NB-IoT), among others. Such iterations may include reduced capability (RedCap) devices and enhanced reduced capability (eRedCap). Some enhanced RedCap devices may have lower bandwidth capabilities, whether in the radio frequency (RF) domain or in the baseband (BB) domain.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a first network entity may include: at least one memory; at least one transceiver; and at least one processor coupled to the at least one memory and the at least one transceiver, wherein the first network entity is configured to: receive, from a second network entity, a first instance of information on a first sub-band of a bandwidth part and a second instance of the information on a second sub-band of the bandwidth part, wherein the first instance of the information and the second instance of the information fully overlap in time; and operate in a mode, wherein: the mode is a first mode in which the first network entity is configured to: filter the first instance of the information to generate first sub-band information and filter the second instance of the information to generate second sub-band information; generate, based on combining information including an amplitude parameter and a phase parameter, an analog combination of the first sub-band information and the second sub-band information, wherein the analog combination is a weighted sum of the first sub-band information and the second sub-band information; and process the analog combination; the mode is a second mode in which the first network entity is configured to: convert the first instance of the information on the first sub-band to baseband and separately convert the second instance of the information on the second sub-band to baseband; sample the first instance of the information at baseband to generate first sampled information and sample the second instance of the information at baseband to generate second sampled information; process the first sampled information according to a first timeline; and process the second sampled information according to a second timeline; the mode is a third mode in which the first network entity is configured to: simultaneously convert the first instance of the information on the first sub-band and the second instance of the information on the second sub-band together to baseband; sample the first instance of the information and the second instance of the information together at baseband to generate third sampled information, wherein a first portion of the third sampled information corresponds to the first instance of the information, and wherein a second portion of the third sampled information corresponds to the second instance of the information; process the first portion according to a third timeline; and process the second portion according to a fourth timeline; or the mode is a fourth mode in which the first network entity is configured to: process data associated with the first instance of the information; and perform energy harvesting on the second instance of the information.

In an additional aspect of the disclosure, a first wireless communication device may include at least one memory; at least one transceiver; and at least one processor coupled to the at least one memory and the at least one transceiver, wherein the first wireless communication device is configured to: receive an indication, from a second network entity on an uplink (UL) transmission, of a capability of the second network entity to operate in a mode in which the second network entity acts with respect to multiple instances of data or multiple instances of a signal within a bandwidth part and overlapping in a time domain; and transmit, based on the indication, on a downlink (DL) transmission a first instance of information on a first sub-band and a second instance of the information on a second sub-band, wherein the first instance of the information and the second instance of the information fully overlap in the time domain.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention may include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances may be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example schematic of an organization of wireless resources in an air interface utilizing orthogonal frequency divisional multiplexing (OFDM), according to some aspects of the present disclosure.

FIG. 4 illustrates example bandwidth parts which may be adapted for use in some aspects of the present disclosure.

FIG. 5 illustrates an example bandwidth part, a first instance of information, and a second instance of information, for use in some aspects of the present disclosure.

FIG. 6 illustrates an example combining process, for use in some aspects of the present disclosure.

FIG. 7 an example second mode, which may be performed by a first network entity, according to some aspects of the present disclosure.

FIG. 8 illustrates an example timeline, which may be used for channel state information (CSI) functionality, according to some aspects of the present disclosure.

FIG. 9 illustrates an example third mode, which may be performed by a first network entity, according to some aspects of the present disclosure.

FIG. 10 an example fourth mode, which may be performed by a first network entity, according to some aspects of the present disclosure.

FIG. 11 illustrates an example power splitter architecture 1100, which may be used with the method 1000, according to some aspects of the present disclosure.

FIG. 12 is a signal diagram illustration of example communications between a first network entity and a second network entity, according to some aspects of the present disclosure.

FIG. 13 illustrates an example user equipment, which may be used according to some aspects of the present disclosure.

FIG. 14 illustrates an example base station, which may be used according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3^{rd} Generation Partnership Project” (3GPP), and cdma2000 is described in documents from an organization named “3^{rd} Generation Partnership Project 2” (3GPP2). These various radio technologies and standards are known or are being developed. For example, the 3^{rd} Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km2), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜ 10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments.

For example, in various outdoor and macro coverage deployments of less than 3 GHZ FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHZ, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHZ bands allows for hundreds of megahertz (MHz) of bandwidth (BW) available for unlicensed band communications. Additionally, NR-U may also be deployed over 2.4 GHZ unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHZ LBT sub-bands for sidelink communications. A sidelink resource pool is typically allocated with multiple frequency subchannels within a sidelink band width part (SL-BWP) and a sidelink UE may select a sidelink resource (e.g., one or multiple subchannel) in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

Various aspects relate generally to wireless communication and more particularly to network entities (e.g., a base station—BS—or a user equipment—UE) and methods that support operation in one or more modes. Each of the modes includes operation in which a first instance of information on a first sub-band of a bandwidth part and a second instance of the information on a second sub-band of the bandwidth part are transmitted by a BS and received by a UE. For instance, the first instance of the information may be a signal, such as a sounding reference signal (SRS), and the second instance of the information may also be the same signal on a different sub-band and fully overlapped in time, such as by being included in a same symbol. In another example, the information may include data, such that the first instance of the information may be a data transport block on a PDSCH or other channel, and the second instance of the information may be the same data on a different sub-band and fully overlapping in time.

An example of a first mode includes a first network entity (e.g., a UE) filtering the first instance of the information to generate first sub-band information and also filtering the second instance of the information to generate second sub-band information. The first mode may also include the first network entity combining the first sub-band information and the second sub-band information. For instance, the combining may be based on combining information, such as an amplitude parameter and a phase parameter, and take place in the radio frequency (RF) domain. The first mode may also include processing an analog combination that is a weighted sum resulting from combining the first sub-band information and the second baseband.

Particular aspects of the first mode may be implemented to realize potential advantages. An example potential advantage includes allowing a device, having a smaller baseband bandwidth than an RF bandwidth, to process the analog combination to achieve greater reliability. For instance, the analog combination itself may be less affected by noise than either one of the first baseband signal or the second baseband signal. Thus, the analog combination may provide greater reliability than can be achieved by decoding either one of the first baseband signal or the second baseband signal on its own and without exceeding the baseband bandwidth of the device.

An example of a second mode includes a first network entity (e.g., a UE) converting a first instance of information on the first sub-band to baseband and separately converting a second instance of information on the second sub-band to baseband. The first network entity may then sample the first instance of the information at baseband to generate first sampled information and also sample the second instance of the information at baseband to generate second sampled information. The first network entity may store the first sampled information and the second sampled information in separate memory spaces, e.g., buffers. The second mode may further include the first network entity processing the first sampled information according to a first timeline and processing the second sampled information according to a second timeline.

Particular aspects of the second mode may be implemented to realize potential advantages. An example potential advantage includes allowing the first network entity to combine the first instance of the information and the second instance of the information when appropriate to, e.g., increase reliability. For instance, if processing the first sampled information fails, then the first network entity may combine the first sampled information and the second sampled information in the digital domain and then process the resulting combined information. In some instances, the combined information may be less affected by noise than either one of the first sampled information or second sampled information on its own. In another aspect, the first network entity may provide a channel state information report corresponding to the first sub-band and then, subsequently, provide a channel state information report corresponding to the second sub-band. In other words, another potential advantages that the first network entity may measure channel state and report on channel state for multiple sub-bands.

An example of a third mode includes the first network entity (e.g., a UE) simultaneously converting the first instance of information on the first sub-band and the second instance of information on the second sub-band together to baseband and sampling the first instance of the information and the second instance of the information together at baseband to generate third sampled information. Further in this example, a first portion of the third sampled information may correspond to the first instance of the information, and a second portion of the third sampled information may correspond to the second instance of the information. Furthermore, the sampling may include oversampling the entire time domain signal. In some aspects, the third sampled information may be written in a memory space, such as a circular buffer. As the first network entity operates, it may read from the memory space in order to process the first portion according to a third timeline and process the second portion according to a fourth timeline.

Particular aspects of the third mode may be implemented to realize one or more potential advantages, which may be similar to the potential advantages of the second mode. An example potential advantage includes allowing the first network entity to combine the first instance of the information and the second instance of the information when appropriate to, e.g., increase reliability. For instance, if processing the first portion fails, then the first network entity may combine the first portion and the second portion in the digital domain and then process the resulting combined information. In some instances, the combined information may be less affected by noise than either one of the first sampled information or second sampled information on its own. Similarly to the second mode, the third mode may also allow for the first network entity to measure channel state and report on channel state for multiple sub-bands.

An example of a fourth mode includes the first network entity (e.g., a UE) processing data associated with the first instance of the information and performing energy harvesting on the second instance of the information. For instance, the fourth mode may include the network entity combining the first instance of the information and the second instance of the information for increased reliability during some times and, at other times, only processing the data associated with the first instance of the information and performing energy harvesting on the second instance of the information.

Particular aspects of the fourth mode may be implemented to realize one or more potential advantages. An example of a potential advantage may include allowing the first network entity flexibility to harvest energy when appropriate and to increase reliability when appropriate.

While the examples herein refer to a first instance of information and a second instance of information, the scope of aspects may include further instances of information overlapping in time. In other words, some aspects may include more than two instances of the information, as the modes described herein apply just as well to three, four, or more instances of information.

Other aspects may include a network entity that is configured to operate in a mode, wherein the mode is the first mode, is the second mode, is the third mode, or is the fourth mode. Further aspects may also include a method in which a network entity operates in a mode, wherein the mode is the first mode, is the second mode, is the third mode, or is the fourth mode. Moreover, additional aspects may include actions performed by a second network entity (e.g., a base station). For instance, a second network entity may receive an indication of capabilities by the first network entity and may coordinate with the first network entity to allow the first network entity to operate in any one of the first mode, the second mode, the third mode, or the fourth mode. For instance, the second network entity may transmit the first instance of the information and the second instance of the information to the first network entity. The second network entity may also coordinate with the first network entity to allow the first network entity to switch between modes.

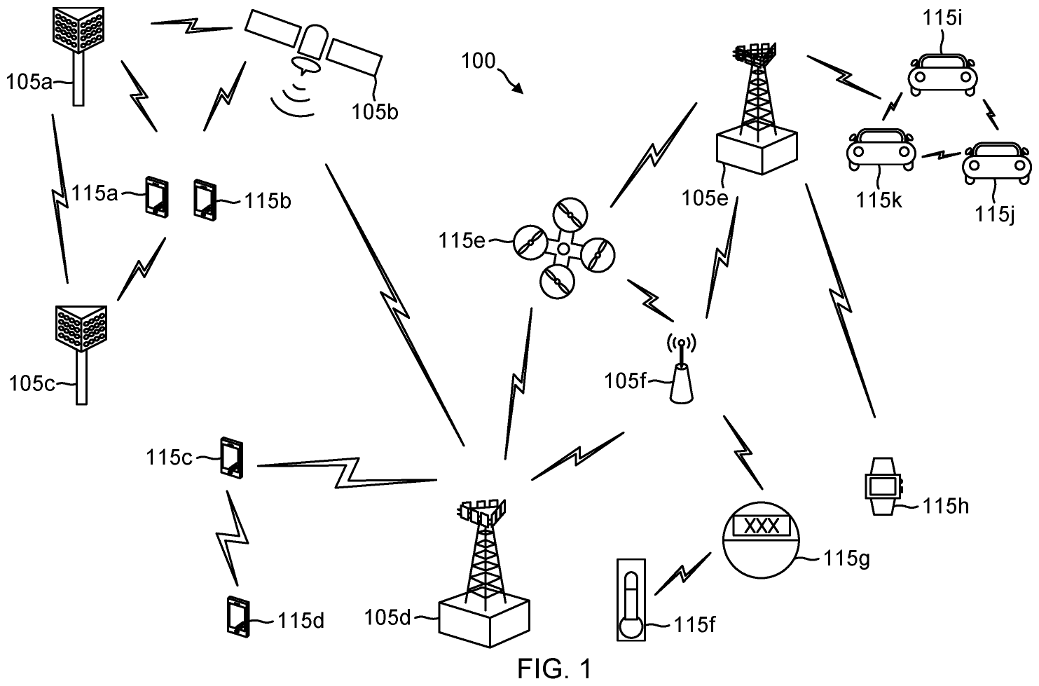

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” may refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100.

A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into sub-bands. In other instances, the subcarrier spacing and/or the duration of TTIs may be scalable.

In some instances, the BSs 105 may assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication may be in the form of radio frames. A radio frame may be divided into a plurality of subframes, for example, about 10. Each subframe may be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes may be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal may have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe may be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 may transmit synchronization signals (e.g., including a primary synchronization signal (PSS) and a secondary synchronization signal (SSS)) in the network 100 to facilitate synchronization. The BSs 105 may broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 may perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 may enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

Any of the UEs 115 of FIG. 1 may be adapted to perform the techniques described below with respect to FIGS. 6-12, such as by operating in one or more modes with respect to signals or data fully overlapping in time and in different sub-bands. Furthermore, any of the BSs 105 of FIG. 1 may be adapted to perform the techniques described below with respect to FIGS. 6-11, such as by transmitting signals or data fully overlapping in time and in different sub-bands or communicating with a UE 115 regarding a mode of operation of the UE 115.

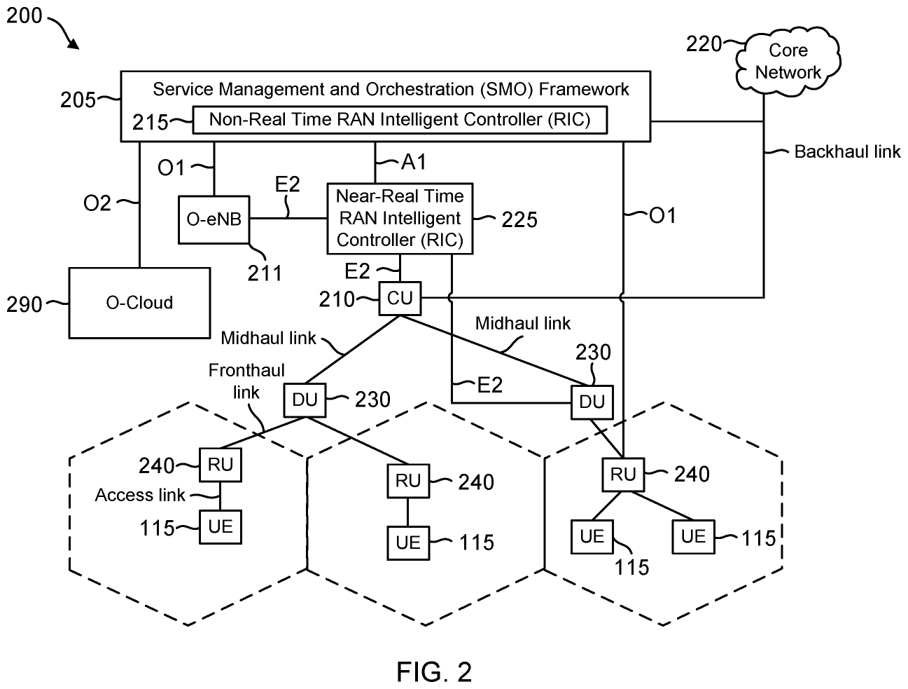

FIG. 2 shows a diagram illustrating an example disaggregated base station architecture 200. The disaggregated base station architecture 200 may include one or more central units (CUs) 210 that may communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 115 via one or more radio frequency (RF) access links. In some implementations, the UE 115 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units.

Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 may be logically split into one or more CU-UP units and one or more CU-CP units. The CU-UP unit may communicate bidirectionally with the CU-CP unit via an interface, such as the E1 interface when implemented in an O-RAN configuration. The CU 210 may be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) may be implemented with an interface configured to communicate signals with other layers (and modules) hosted by the DU 230, or with the control functions hosted by the CU 210.

Lower-layer functionality may be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 may be implemented to handle over the air (OTA) communication with one or more UEs 115. In some implementations, real-time and non-real-time aspects of control and user plane communication with the RU(s) 240 may be controlled by the corresponding DU 230. In some scenarios, this configuration may enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements may include CUs 210, DUs 230, RUs 240 and Near-RT RICs 225. In some implementations, the SMO Framework 205 may communicate with a hardware aspect of a 4G RAN, such as an open eNB (O-eNB) 211, via an O1 interface. Additionally, in some implementations, the SMO Framework 205 may communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

Any of the UEs 115 of FIG. 2 may be adapted to perform the techniques described below with respect to FIGS. 6-12, such as by operating in one or more modes with respect to signals or data fully overlapping in time and in different sub-bands. Furthermore, a BS 105 of FIG. 1, when implemented according to the architecture 200 of FIG. 2, may be adapted to perform the techniques described below with respect to FIGS. 6-12, such as by transmitting signals or data fully overlapping in time and in different sub-bands were communicating with a UE 115 regarding a mode of operation of the UE 115.

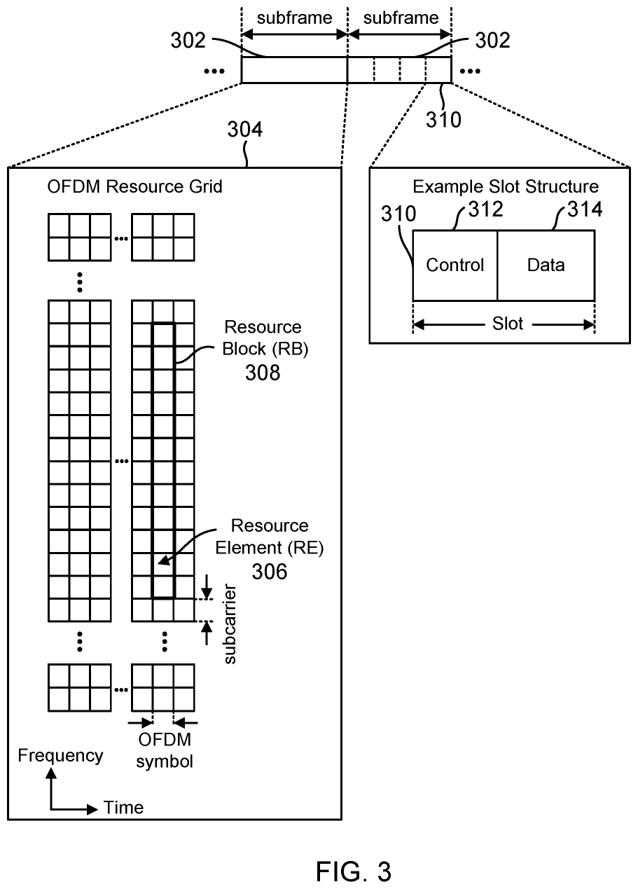

FIG. 3 illustrates an example schematic of an organization of wireless resources in an air interface utilizing orthogonal frequency divisional multiplexing (OFDM), according to some aspects of the present disclosure. Various aspects of the present disclosure may be applied, for example, to a DFT-s-OFDMA or an SC-FDMA waveform in substantially the same way as described herein below. That is, while some examples of the present disclosure may focus on an OFDM link for clarity, it should be understood that the same principles may be applied as well to DFT-s-OFDMA or SC-FDMA waveforms. In FIG. 3, an expanded view of an exemplary subframe 302 is illustrated, showing an OFDM resource grid. However, as those skilled in the art can readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The radio frame structure or resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. A RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, in some aspects, it can be assumed that a single RB such as the RB 308 entirely corresponds to a single direction of communication (either transmission or reception for a given device).

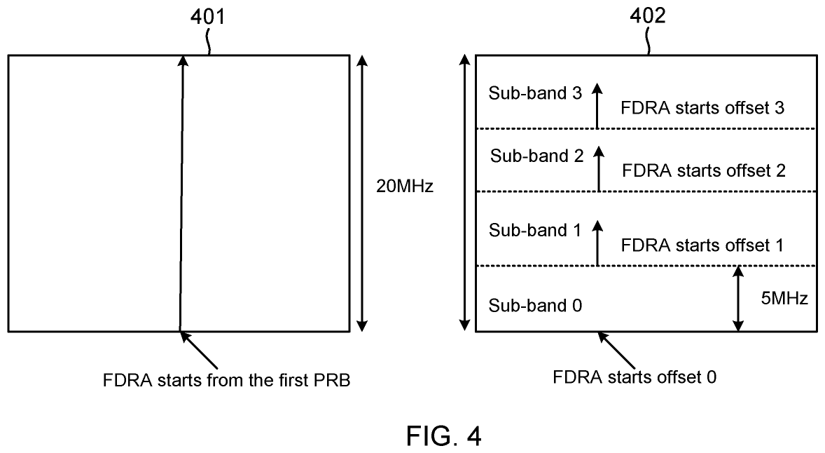

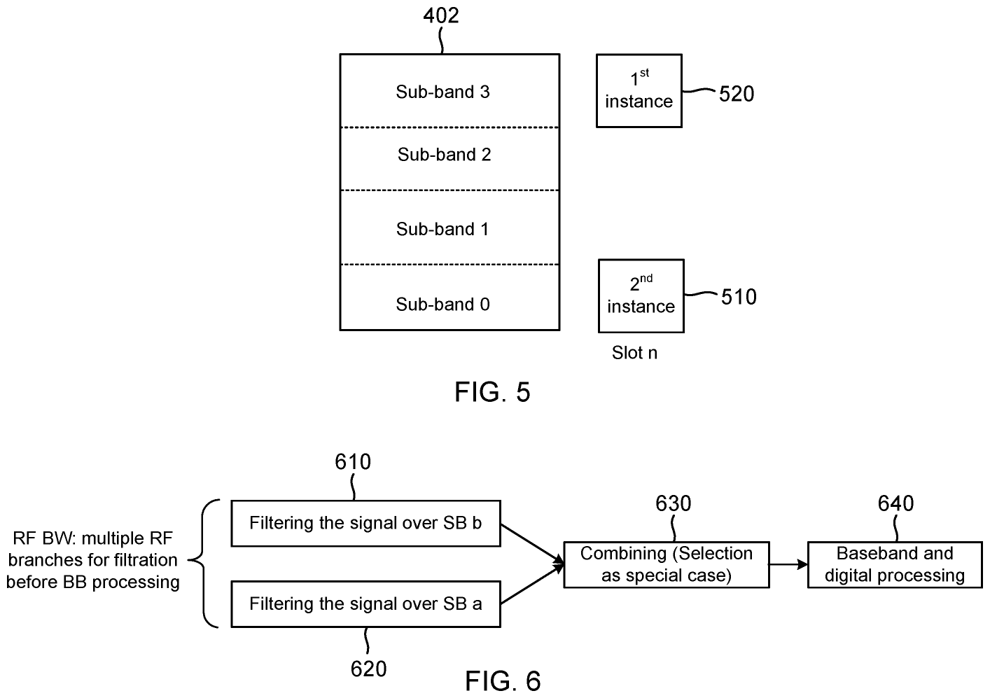

A contiguous set of PRBs having the same subcarrier spacing form a bandwidth part (BWP). Furthermore, a given BWP may include multiple sub-bands, where each sub-band includes one or more PRBs. A relationship of BWPs and sub-bands is discussed in more detail with respect to FIGS. 4-5.

Scheduling of UEs or sidelink devices (hereinafter collectively referred to as UEs) for downlink, uplink, or sidelink transmissions typically involves scheduling one or more resource elements 306 within one or more sub-bands. Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

According to some examples, a frame may refer to a duration of 10 ms, with each frame sub-divided into 10 subframes 302 of 1 ms each. Each 1 ms subframe may consist of one or multiple adjacent slots. In the example shown in FIG. 2, subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., 1, 2, or 3 OFDM symbols). These mini-slots, or shortened TTIs, may in some cases be transmitted occupying resources scheduled for ongoing slot transmissions for the same or for different UEs. Any number of resource blocks may be utilized within a subframe or slot.

An expanded view of one of the slots 310 illustrates the slot as including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The simple structure illustrated in FIG. 2 is merely exemplary in nature, and different slot structures may be utilized, and may include one or more of each of the control region(s) and data region(s).

Although not illustrated in FIG. 2, the various REs 306 within an RB 308 may be scheduled to carry one or more physical channels, including control channels, shared channels, data channels, etc. Other REs 306 within the RB 308 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, the slot 310 may be utilized for broadcast or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a PBCH; a PSS; a SSS; a physical control format indicator channel (PCFICH); a physical hybrid automatic repeat request (HARQ) indicator channel (PHICH); and/or a physical downlink control channel (PDCCH), etc., to one or more scheduled entities (e.g., UEs). The PCFICH provides information to assist a receiving device in receiving and decoding the PDCCH. The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PHICH carries HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In an UL transmission, the scheduled entity may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), or any other suitable UCI.

In addition to control information, one or more REs 306 (e.g., within the data region 314) may be allocated for user data traffic. Such traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry system information blocks (SIBs), carrying information that may enable access to a given cell.

In an example of sidelink communication over a sidelink carrier via a PC5 interface, the control region 312 of the slot 310 may include a physical sidelink control channel (PSCCH) including sidelink control information (SCI) transmitted by an initiating (transmitting) sidelink device (e.g., V2X or other sidelink device) towards a set of one or more other receiving sidelink devices. The PSCCH may include HARQ feedback information (e.g., ACK/NACK) that may be used to indicate a need, or lack of need, for retransmissions on the sidelink. The data region 314 of the slot 310 may include a physical sidelink shared channel (PSSCH) including the data transmitted by the initiating (transmitting) sidelink device within resources reserved over the sidelink carrier by the transmitting sidelink device.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above are not necessarily all the channels or carriers that may be utilized between a scheduling entity 108 and scheduled entities (e.g., one of more UE 106), and those of ordinary skill in the art may recognize that other channels or carriers may be utilized in addition to those illustrated, such as other traffic, control, and feedback channels.

FIG. 4 illustrates example BWPs 401, 402, which may be adapted for use in some aspects of the present disclosure. BWP 401 has not been divided into multiple sub-bands. The frequency domain resource allocation (FDRA) starts from a first PRB and ends at a last PRB. Both BWPs 401, 402 have a total bandwidth of 20 MHz in this example.

BWP 402 has been partitioned into multiple sub bands 0-3. The FDRA of BWP 400 to begins at its first PRB having an offset of zero. Each subsequent sub-band has another non-zero offset. For instance, sub-band 1 as a first offset (offset 1), and the first offset is an integer number of PRBs.

In some aspects, a starting point of a given one of the sub-bands may be determined with respect to the PRB0 of the BWP 402 and based on the subcarrier spacing (SCS) of the BWP 402. The offset may be determined based on a maximum UE BW e.g., offset k is k*N_{rb} where N_{rb} is the number of RBs contained in a maximum UE BW. A sub-band may be valid if it contains an integer number of RBs e.g., N_{rb}. The start of FDRA for DL reception is the first RB in a valid sub-band.

In some aspects, the maximum UE BW may correspond to a baseband bandwidth capability of the UE. For instance, some UEs may have a hardware, firmware, or software limitation that may set the baseband bandwidth at a same or smaller bandwidth value than its RF bandwidth. One example may include a device having an RF bandwidth capability of 20 MHz but a baseband bandwidth capability of 5 MHz. Such an arrangement may be found in lower-bandwidth and lower-power devices, such as may be used in IoT and other applications. For instance, a modem of a RedCap or eRedCap device may be limited in its baseband capability by a reduction in hardware that is intended to reduce power use.

Of course, 20 MHz for a BWP and 5 MHz for a sub-band are just examples, and the scope of implementations may include other-sized bandwidth parts and sub-bands. Furthermore, the scope of implementations is not limited to IoT devices nor to devices having a baseband bandwidth capability of 5 MHZ, as it includes any appropriate device of greater or less capability.

FIG. 5 is an illustration of example BWP 402, first instance of information 510, and second instance of information 520, for use in some aspects of the present disclosure. First instance of information 510 and second instance of information 520 are broken out for ease of illustration but are understood to be included within the bandwidth part 402 so that first instance of information is in sub-band 0, and second instance of information 520 is in sub-band 3. Furthermore, the first instance of information 510 and the second instance of information 520 fully overlap in time, such as being in the same slot (e.g., Slot n). Moreover, the information in the first instance 510 and the information in the second instance 520 may be the same. For instance, they may be a same reference signal (e.g., CSI-RS, SSB, RACH) or a same portion of data carried on TBs of a downlink channel, such as PDSCH or PDCCH.

In some aspects, a network entity, such as a UE, may be able to make use of both the first instance of information 510 and the second instance of information 520, even in a scenario in which a baseband capability of the network entity may be equal to a single one of the sub-bands of BWP 402. The examples of FIGS. 6-12 provide illustrations of different modes in which a UE may operate to make use of the first instance of information 510 and the second instance of information 520. For instance, based on data reliability and delay requirements and priority, the UE may decide to spend more energy in operating certain hardware, firmware, or other resources to process more than the default baseband bandwidth to increase reliability or to operate some hardware to additionally sample and buffer the instances 510, 520 for certain applications or packets.

In some aspects, an example first mode includes the first network entity (e.g., a UE) filtering a first instance of the information (e.g., instance 510) to generate first sub-band information and filtering the second instance of the information (e.g., instance 520) to generate second sub-band information. The first mode may also include the first network entity combining the first sub-band information and the second sub-band information. The combining may be based on combining information, such as an amplitude parameter and a phase parameter. The first mode may also include the first network entity processing an analog combination that is a weighted sum resulting from combining the first sub-band information and the second sub-band information.

FIG. 6 is a flowchart illustration of an example combining process, for use in some aspects of the present disclosure and with respect to the first mode. Actions 610, 620 include filtering the signal over two different respective sub-bands. For instance, in the example of FIG. 5, the sub-bands are sub-band 0 and sub-band 3. Each sub-band, when in the RF domain, may have a component on one side of the center frequency and another component on the other side of the RF center frequency. Therefore, the filtering may include blocking one of the components and passing the other of the components. The filtering may subsequently include adjusting each of the components to align with the RF center frequency. In an example in which each one of the sub-bands is 5 MHz, at this point of filtering, each one of the instances 510, 520 has 5 MHz of bandwidth and is centered along the RF center frequency.

Action 630 may include combining the instances 510, 520 in the analog domain. A waveform associated with the first instance 510 may be expressed as A₁(t) cos (ω₁t), where A1 represents an amplitude of the first instance of information, and cos (ω₁t) represents a frequency associated with a first sub-band (e.g., sub-band 0). Similarly, a waveform associated with the second instance 520 may be expressed as A₂(t) cos (ω₂t), where A2 represents an amplitude of the second instance of information, and cos (ω₂t) represents a frequency associated with a second sub-band (e.g., sub-band 3). After filtering and/or frequency conversion, each of the instances 510, 520 is extracted and aligned along the same center frequency, e.g., ω₀. The center frequency ω₀ may be equal to ω₁ or ω₂, or the center frequency may be baseband ω₀=0.

The combining may be based on an amplitude parameter and a phase parameter in some aspects. For instance, the waveform associated with the first instance 510 may be represented as B₁A₁(t) cos (ω₀t+ϕ1), where B1 is an amplitude parameter, and ϕ₁ is a phase parameter. Similarly, the waveform associated with the second instance 520 may be represented as B₂A₂(t) cos (ω₀t+ϕ₂), where B2 is an amplitude parameter, and ϕ₂ is a phase parameter. The amplitude parameters B1, B2 may be the same or different and may be zero in some instances. Similarly, the phase parameters ϕ₁ and ϕ₂ may be the same or different and may be zero in some instances.

As noted above, each of the instances 510, 520 may be aligned along the RF center frequency. The filtering actions 610, 620 may further include down-converting the instances 510, 520 to baseband, thereby generating first sub-band information from the first instance 510 and second sub-band information from the second instance 520. The first sub-band information may include a first baseband signal A₁(t) cos (ϕ₁), and the second sub-band information may include a second baseband signal A₂(t) cos (ϕ₂). Therefore, an analog combination of the first sub-band information and the second sub-band information may take the form of a weighted sum, expressed as B₁A₁(t) cos (ϕ₁)+B₂A₂(t) cos (ϕ₂).

In an example in which each instance 510, 520 has 5 MHz of bandwidth, the weighted sum B₁A₁(t) cos (ϕ₁)+B₂A₂(t) cos (ϕ₂) also has 5 MHz of bandwidth. In an example in which the baseband capability of the first network device is limited to less than the full RF bandwidth of bandwidth part 402, such as being limited to only 5 MHZ, the combining action 630 allows the first network device to make use of both instances 510, 520. Furthermore, the weighted sum may be less affected by noise than either one of the instances 510, 520 on its own.

Returning to the amplitude and phase parameters, either or both of the UE or BS may play a role in determining those parameters. For instance, in some aspects, a UE may transmit the SRS, which the BS uses to calculate a precoder matrix (PMI) and a modulation coding scheme (MCS). The BS may use the same channel information it gathers for calculating PMI and MCS for calculating the amplitude and phase parameters. For instance, the network may perform calculations based on RSRP and SRS to determine appropriate amplitude and phase parameters to provide desired Signal Interference+Noise Ratio (SINR) or MCS of the combined signal. The amplitude and phase parameters may be determined by the UE in some aspects based on a reference signal, e.g., CSI-RS, and using channel state from CSI-RS to calculate the amplitude and phase parameters to improve a parameter such as SINR.

As noted above, the instances 510, 520 may be a same reference signal or have a same data content. In an example in which the instances 510, 520 are data, the network may use a same redundancy version (RV) for the data in the instances 510, 520. When the RV is the same for both of the instances 510, 520, that allows the combining of action 630 to be performed in the analog domain and before the data undergoes analog to digital conversion. Put another way, in an example in which the data in the data instances 510, 520 has a same RV, the informational content in each of the instances 510, 520 is the same, the effects of noise notwithstanding. On the other hand, should a different RV be used for each of the instances 510, 520, the informational content in the respective TBs would be different and may, therefore, prevent combining in the analog domain. In some aspects, RV 0 and RV 3 are self-decodable and may be appropriate for use.

In another aspect, the combining may include zeroing out one of the instances 510 or 520. For instance, a disparity in SINR between the two instances 510, 520 may favor using only one of the instances (e.g., instance 510) and setting the amplitude parameter B to zero for the other one of the instances (e.g., instance 520). In fact, the combining of action 630 may act like selecting one signal or the other by setting the amplitude parameter B of one of the instances to zero.

Action 640 includes baseband processing and digital processing. For instance, action 640 may include, among other things, sampling, analog-to-digital conversion, Fast Fourier Transform (FFT) processing, and the like. Action 640 may include performing a decoding operation on the analog combination to obtain the information corresponding to the first instance of the information and the second instance of the information.

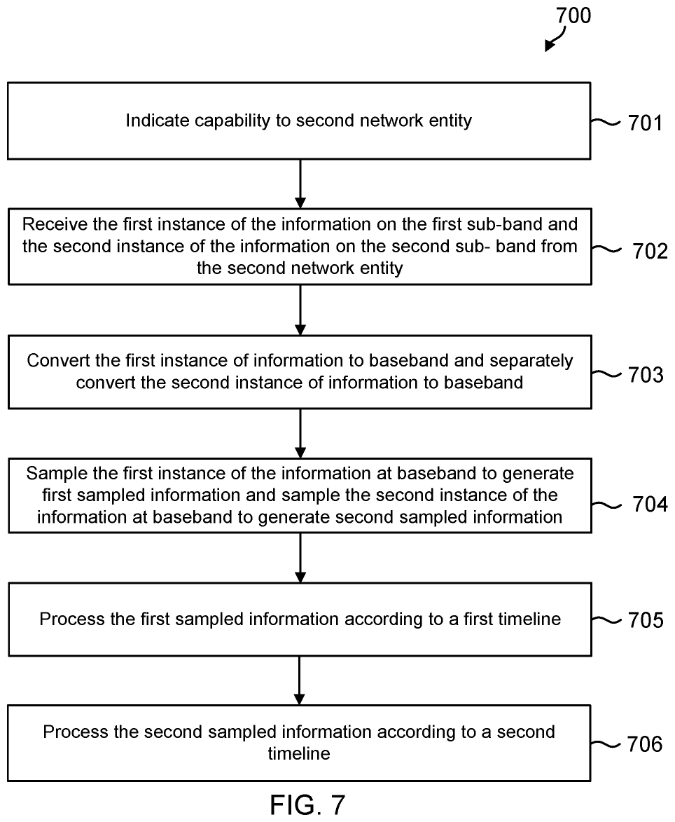

FIG. 7 illustrates an example second mode, which may be performed by a first network entity, according to some aspects of the present disclosure. The example second mode is illustrated by method 700. At action 701, the first network entity (e.g., a UE) indicates capability to a second network entity (e.g., a BS). For instance, the first network entity may indicate its capability to store a time domain version of a first instance of information and a second instance of information. Furthermore, the capability of the first network entity may be attributable, in part, to separate RF chains to filter different sub-bands and different memory spaces (e.g., buffers) in which to write the first instance of the information and the second instance of the information.

At action 702, the first network entity receives the first instance of the information on the first sub-band and the second instance of the information on the second sub-band from the second network entity. An example is shown at FIG. 5, in which the instances 510, 520 are on different sub-bands of the BWP 402 and contain the same information content. At action 703, the first network entity may convert the first instance of information on the first sub-band to baseband and separately convert the second instance of information on the second sub-band to baseband. For instance, action 703 may include separate RF chains within the hardware of the first network entity to filter each respective instance 510, 520 and then downconvert the filtered instances to baseband. An example of action 703 may include wideband RF down conversion to wideband baseband.

At action 704, the first network entity samples the first instance of the information at baseband to generate first sampled information. Action 704 may further include the first network entity sampling the second instance of the information at baseband to generate second sampled information. Action 704 may also include writing the first sampled information to a first memory space and the second sampled information to a second memory space that is separate from the first memory space. An example of separate memory spaces may include separate buffers or other appropriate memory spaces.

At action 705, the first network entity processes the first sampled information according to a first timeline. Similarly, at action 706, the first network entity processes the second sampled information according to a second timeline.

According to one aspect, method 700 may be performed to increase the reliability of data. For example, the first network entity may store both of the instances 510, 520 at action 704 and then attempt to process the instances serially at actions 705, 706. Serially processing the instances may include attempting to decode instance 510 and then, in response to decoding failing, attempting to decode instance 520. On the other hand, if the attempt to decode instance 510 succeeds, then the first network entity may then flush the buffer of instance 520.

In another example, the first network entity may determine that it has a level of stored energy or capability sufficient to combine log likelihood ratios (LLRs) of the first sampled information and the second sampled information. The first network entity may combine a first LLR of the first sampled information with a second LLR of the second sampled information to generate a combined sampled information. The first network entity may then process the combined sampled information. Such technique may increase the power gain of received data when a same RV is used or increase the coding gain of the received data if different RVs are used.

In other aspects, method 700 may be used to increase the reliability of channel estimation by using information to estimate statistics of the channels. Example statistics of the channels may include Doppler spread, delay spread, and Doppler shift. Such statistics may be used for channel estimation or prediction according to CSI or a demodulation reference signal (DMRS). Or the method 700 may be used to select between different sub-bands for communications by measuring channel metrics on those multiple sub-bands and then causing the first network entity to choose a sub-band having desired metrics (e.g., SINR, MCS, channel quality information, rank indicator, or PMI).

In another aspect, method 700 may be used for CSI reporting. For instance, the network may send CSI reference signals (CSI-RSs) overlapping in time, such as in an example in which instances 510 and 520 are CSI-RSs. In such an example, actions 705, 706 may include the first network entity providing a CQI report for the first instance 510 followed by providing an additional CQI report for the second instance 520.

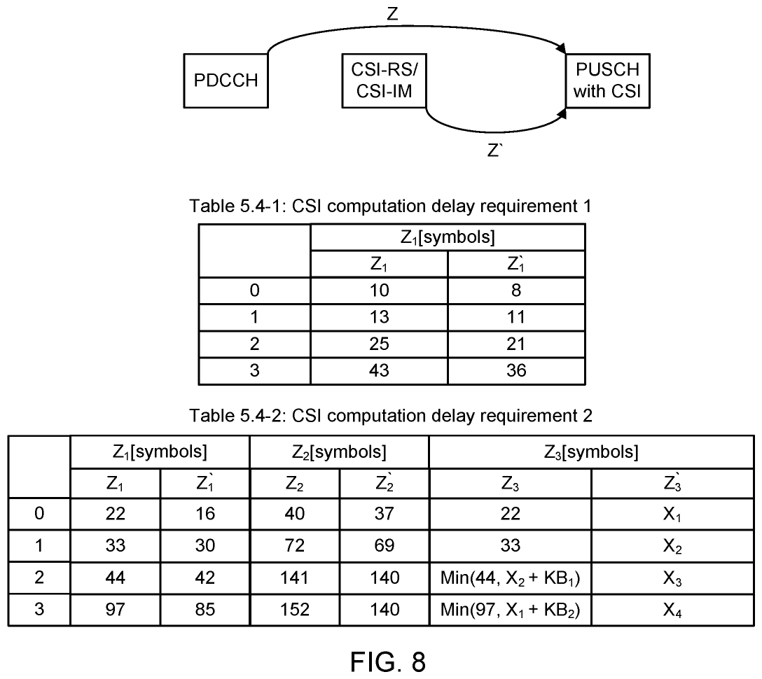

FIG. 8 provides an example timeline, which may be used for CSI functionality, according to example method 700, in some aspects of the present disclosure. In FIG. 8, Z is defined as a time from a last PDCCH symbol to a first UL Tx symbol, and Z′ is defined as time from an end of a CSI-RS symbol to a first UL TX symbol. The times Z and Z′ are defined in TS 38.214 section 5.4, where requirement 1 is a low latency case and requirement 2 is a normal case with Z1 being medium latency, Z2 being high latency, and Z3 being for RSRP. The tables 5.4-1 and 5.4-2 are re-created in FIG. 8 for reference. Some aspects may select a Z and Z′ from table 5.4-2 and Z1 or Z2 to provide an appropriate latency for transmitting a CQI report for instance 510 and then a subsequent CQI report for instance 520. For instance, increasing a latency may allow for serial measurements and CQI report generation at the first network entity as actions 705, 706.

Also, ordering or ranking of sub-band CSI reporting may be considered when determining which CQI reports to send and when. The order or ranking may be configured by the network or based on UE implementation but in any event may be known at the network. Furthermore, CSI may have a sub-band identifier (if configured to be sent). In some cases, the first network entity may make a single report with all sub-band CSI information.

In some aspects, method 700 may be used for positioning. For positioning, the first network entity may use the different CSI-RS transmitted on the multiple sub-bands (or resources) to determine or enhance positioning measurement, including adjusting the timing advance or RSRP measurement among other purposes (e.g., computing statistics of channels for positioning enhancements).

In one example including positioning functionality, the first network entity may receive, from the second network entity, a first downlink (DL)-positioning reference signal (PRS) on the first sub-band. The first network entity may also receive, from the second network entity, a second DL-PRS on the first sub-band. The first network entity may then transmit report information to the second entity, wherein the report information is based on the first DL-PRS and the second DL-PRS.

The report information may include information indicative of the first DL-PRS and information indicative of the second DL-PRS. The information indicative of the first DL-PRS may include first position-related information associated with the first DL-PRS or a first reference signal received power (RSRP), and the information indicative of the second DL-PRS may include second position-related information associated with the second DL-PRS or a second RSRP. The first network entity may generate the report information based on the first DL-PRS and the second DL-PRS or may adjust first information based on the first DL-PRS and the second DL-PRS to generate adjusted first information. The report information may include the adjusted first information, and the first information may include position-related information.

Continuing with the example, the first DL-PRS may include a first channel state information (CSI)-reference signal (RS), and the second DL-PRS may include a second CSI-RS.

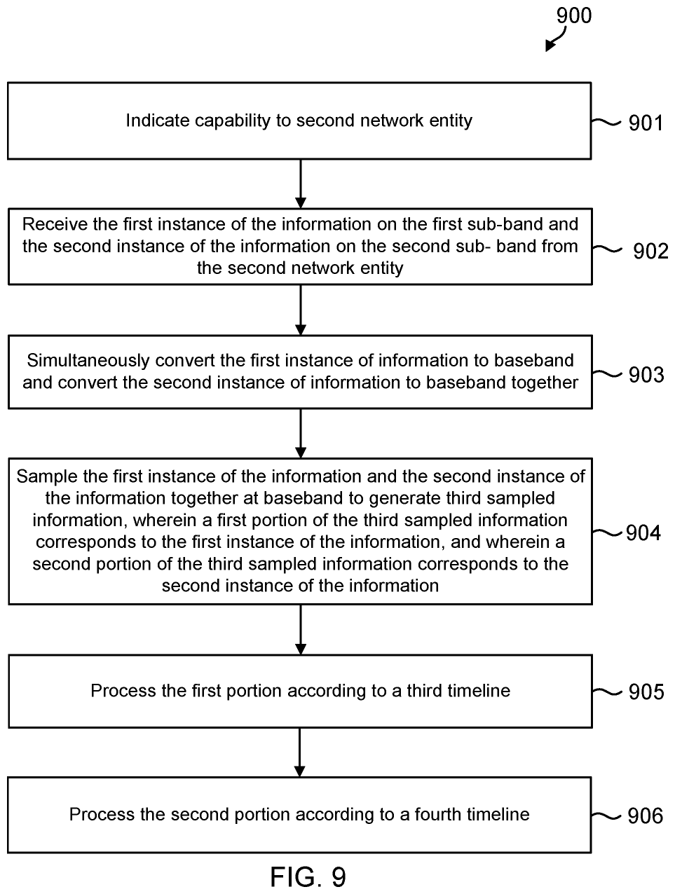

FIG. 9 illustrates an example third mode, which may be performed by a first network entity, according to some aspects of the present disclosure. The example third mode is illustrated by method 900. At action 901, the first network entity (e.g., a UE) indicates capability to a second network entity (e.g., a BS). For instance, the first network entity may indicate its capability to store a time domain version of the first instance of the information and the second instance of the information. Furthermore, the capability of the first network entity may be attributable, in part, to a memory space (e.g., a circular buffer) in which to write the first instance of the information and the second instance of the information together.

At action 902, the first network entity receives the first instance of the information on the first sub-band and the second instance of the information on the second sub-band from the second network entity. An example is shown at FIG. 5, in which the instances 510, 520 are on different sub-bands of the BWP 402 and contain the same information content.

At action 903, the first network entity simultaneously converts the first instance of information on the first sub-band to baseband and converts the second instance of the information on the second sub-band to baseband. In one example of action 903, the first network entity treats the entirety of the bandwidth part so that it converts each of the different sub-bands to baseband together. An example of action 903 may include wideband RF down conversion to wideband baseband.

At action 904, the first network entity samples the first instance of the information and the second instance of the information together at baseband to generate third sampled information. Further in this aspect, a first portion of the third sampled information corresponds to the first instance of the information (e.g., instance 510), and a second portion of the third sampled information corresponds to the second instance of the information (e.g., instance 520). Action 904 may include the first network entity storing the samples of the bandwidth part in the time domain together in a same memory space. An example of a memory space may be a circular buffer; however, any appropriate memory space may be used. In some examples, action 904 may include oversampling of the baseband information, where the sampling rate may be X times (where X is a number larger than 1) of the baseband signal.

Actions 905 and 906 include the first network entity processing the first portion according to a third timeline and processing the second portion according to a fourth timeline, where the third and fourth timelines are different. Such action is similar to the actions 705 and 706 of FIG. 7, where relaxed timelines as in FIG. 8 may be used to provide separate processing for the information that corresponds to the respective instances 510, 520. Processing may include, e.g., discrete Fourier transform (DFT), fast Fourier transform (FFT), or other digital signal processing on the samples.

In method 900, a first network entity may store the samples in the time domain and filter one of the portions first (e.g., the first portion). Subsequently, the first network entity may filter the other portion (e.g., the second portion). For instance, the first network entity may combine the LLRs of the two portions to increase a coding gain of the received signal, in an instance in which it may be desirable to increase coding gain. In another example, the data may be used for CSI reporting or location positioning, as in the example of FIG. 7. However, one difference between the examples of FIG. 7 and FIG. 9 is that in FIG. 9 the instances of information are converted to baseband together and then sampled and stored together in a same memory space. Therefore, example method 900 may also include operating within time constraints of the memory space. For example, some types of memory space, such as a circular buffer, may include samples being dropped or flushed after a certain time or when space in the buffer is needed for other information. Accordingly, when using a relaxed timeline, such as in FIG. 8, the first network entity may be programmed so that the samples of a subsequent portion may be used before the samples are flushed.

Some examples may include the second network entity (e.g., a base station) indicating to the first network entity which portion to use. For instance, the second network entity may be aware of signal quality differences between different sub-bands and may instruct the first network entity to process one of the portions (e.g., the first portion) corresponding to better signal quality while letting the second portion go unused and flushed from the memory. On the other hand, the second network entity may instruct the first network entity to process both the first portion and the second portion by combining LLRs to increase coding gain when appropriate.

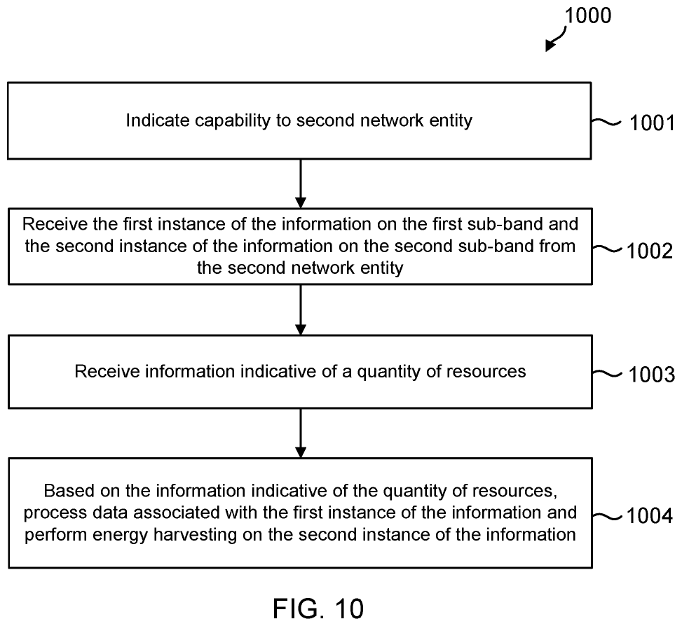

FIG. 10 illustrates an example fourth mode, which may be performed by a first network entity, according to some aspects of the present disclosure. The example fourth mode is illustrated by method 1000. At action 1001, the first network entity (e.g., a UE) indicates capability to the second network entity. Such capabilities may include, e.g., an ability to perform energy harvesting on some frequency domain resources and to process data on other frequency domain resources, where those frequency domain resources may be associated with a same time domain resource (e.g., correspond to a same slot).

At action 1002, the first network entity receives the first instance of the information on the first sub-band and the second instance of the information on the second sub-band from the second network entity. An example is shown in FIG. 5, illustrating bandwidth part 402, first instance of information 510, and second instance of information 520.

At action 1003, the first network entity receives information indicative of a quantity of resources. The information indicative of a quantity of resources may include energy information, such as an indication of current or latest reported charging rate profile, a discharging rate profile, energy state or energy level profile. The information indicative of the quantity of resources may include delay information, such as a packet or application delay requirement, packet delay budget, and the like. Further information may be taken into account, such as data reliability requirement information, packet L1/L2 priorities, and the like.

At action 1004, the first network entity determines to process data associated with the first instance of the information and to perform energy harvesting on the second instance of the information. The determination may be based on the information indicative of a quantity of resources from action 1003. For instance, the first network entity may perform energy harvesting rather than, e.g., processing both the first instance of the information and the second instance of the information, in response to a charging rate profile and a discharging rate profile, which together indicate a predicted decrease in stored energy. Some energy states or energy state profiles may also be associated with conserving energy more so than other energy states or energy state profiles and, thus, may also be associated with energy harvesting. Furthermore, in another example, the first network entity may perform energy harvesting in response to a packet delay budget being relatively large and to forgo energy harvesting in response to the packet delay budget being relatively small. Of course, other aspects of the disclosure may include performance of energy harvesting (or not) based on any appropriate resource quantity or other consideration.

In some aspects, for ambient IoT, where the network provides energy, the baseband capability of a UE may be as small as one RB; however, the RF bandwidth of the UE may be as large as 20 MHz or bigger for energy harvesting. The network may configure the UE with data bandwidth higher than the baseband capability, wherein the UE can select sub-bands or combine sub-bands across the baseband BW. Hence, the UE may use some instances of information for energy at some times and may use at least some of those instances of information as data at other times.

In some aspects, the network may repeat the instances of information across the RF bandwidth of an energy harvesting device to be used for energy transfer. Then, the UE may determine how to leverage the extra instances of information either as energy signals or for improved data reliability.

In some implementations, based on data reliability and delay requirements and priority, the UE may spend more energy in operating certain hardware or firmware to process more than the default baseband BW to increase the reliability (as in the first mode) or to operate some hardware additionally to sample and buffer the signals for certain applications or packets (as in the second mode or the third mode).

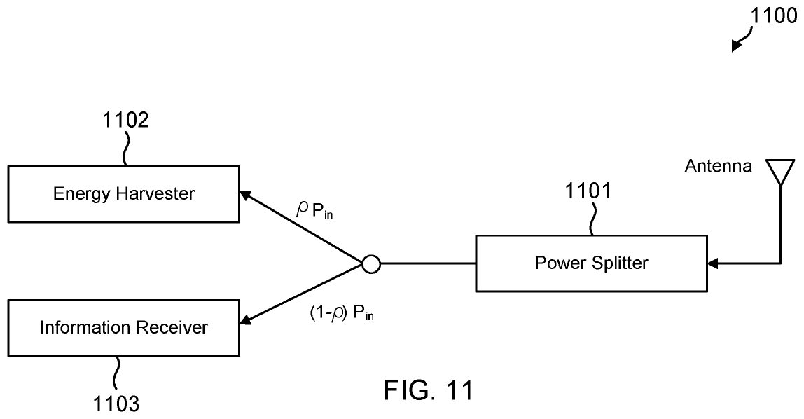

Method 1000 may include a capability of using per-RB or per-set of RB power or sub-band splitting for power splitting. FIG. 11 illustrates an example power splitter architecture 1100, which may be used with the method 1000, according to some aspects of the present disclosure.

The power splitter 1101 may use some instances of information for data processing, such as with information receiver functionality 1103. Power splitter 1101 may also use some instances of information for energy harvesting, such as with energy harvesting functionality 1102. Specifically, the power splitter 1101 may determine different values of p or range of supported values of p. (Pin refers to a total amount of power associated with all received instances of information at a given time.) The system may support power splitting per-RB or per-set of RBs, and a given value of p or given range of supported values of p may correspond to a given number of RBs to be used for energy harvesting out of a total number of RBs received. The power splitter may use a given value of p or range of supported values of p during use to achieve an appropriate energy profile and based on information indicative of a quantity of resources. Similarly, the network may indicate to the UE which value of p or given range of supported values of p to use, and then the UE may implement accordingly.

Some aspects may include a table that defines behavior based on current or latest reported charging rate profile, discharging rate profile, energy state/level profile, packet L1/L2 priorities, packet or application delay requirements, and the like. The first network entity may access the table to match current performance and metrics to table entries and then to select a behavior associated with a matched table entry. Furthermore, the behavior may be implemented at the UE based on signaling from the network at any appropriate layer or interface. Examples of layers and interfaces that may be used include:
Uu link/interface, such as NW in Uu, where L1 corresponds to DCI [scheduling or non-scheduling], L2 corresponds to MAC-CE, and L3 corresponds to RRC;
UE in Uu, where L1 corresponds to UCI carried on PUCCH or PUSCH or dedicated PUSCH, L2 corresponds to MAC-CE, and L3 corresponds to RRC including user assistance information;
UE/NW units in sidelink, where L1 corresponds to SCI, dedicated PSSCH, L2 corresponds to PC5-MAC-CE, and L3 corresponds to PC5-RRC.

Of course, the UE decision may be autonomous or indicated to the network, along with energy reports (of charging/discharging/energy state profiles) or in separate reporting. The network's knowledge of the UE's decision of processing can help in network configuring or using data signals as energy signals. In other designs, some sub-bands may use energy specific signals which cannot be used by a UE to decode data. Energy specific signals may have certain waveforms, modulation, and pulse shaping and may not contain data information.

Operation in any one of the first mode, the second mode, the third mode, or the fourth mode may use more energy than simply discarding one of the instances of information. For instance, an alternative to operating in any of the modes described above may include converting only one of the instances (e.g., the first instance 510) to baseband, sampling, and processing for that instance while omitting to convert the other instance of information (e.g., the second instance 520) to baseband or performing further processing. The modes, as described above, may include more sampling and processing and, therefore, further power use. However, the modes may provide additional capabilities, such as allowing for greater reliability, which may be appropriate given the cost in power in some instances. Therefore, the first network entity may include the capability to operate in one or more of the modes but may operate in a less capable and less power intensive mode as a default. However, when the first network entity has appropriate resources to support either the first mode, the second mode, the third mode, or the fourth mode, the first network entity may then operate in one of those modes.

Examples of resources that may affect a determination to operate in the second or third mode include, e.g., energy availability, current processing tasks and capacity to perform further processing tasks, and time. Other considerations, such as reliability requirements, delay requirements, power saving mode, traffic type (e.g., extended reality, ultra-reliable low latency communication), traffic priority, quality of service (QoS), and the like may also be used when operating in the first mode, the second mode, the third mode, or the fourth mode. Switching between capabilities may be associated with various hardware, software, and firmware components turning on or off, and the switching between capabilities may be controlled, e.g., by a resource running on an operating system of a processor of the first network entity or by any other appropriate resource.

In one aspect, a first network entity may switch from a first modem capability (e.g., eRedCap) to a second modem capability (e.g., RedCap) based on at least one of energy information (charging rate profile, discharging rate or power consumption rate profile, and energy level profile) or traffic information (e.g., traffic type, arrival rate of traffic, density of traffic (time between two arrivals)). For instance, any one of the first mode, the second mode, the third mode, and the fourth mode may be associated with eRedCap or RedCap, whereas more power-intensive or resource-intensive operating modes may be associated with different capabilities, such as extended mobile broadband (eMBB) and the like.

Furthermore, the first network entity may indicate its ability to switch between different modes to the second network entity (e.g., a UE may indicate an ability to a network or base station). An example indication from a UE to a base station may be during RACH or part of capability inquiry and be via L1/L2/L3 interfaces or multiplexed within L1/L2/L3 interfaces. In some aspects, based on certain DL traffic (and/or knowledge of network about the UE's energy information and/or UL traffic information) or network preference for a capable UE to switch, the network may indicate to the UE to switch from one capability to another capability.

As noted above, the indication may be during RACH, or as part of capability inquiry, and may be indicated dynamically through L1/L2/L3 or mux with L1/L2/L3 indications. The first network entity may indicate the ability to switch between any two pairs: RedCap to RedCap (or vise versa), RedCap to eMBB (or vise versa), and the like.

Switching from one of the first mode, the second mode, the third mode, or the fourth mode to a more power intensive or more processing intensive mode may include temporarily increasing a maximum baseband bandwidth capability of the first network entity on a time period-to-time period basis for received data. Temporarily increasing the maximum baseband bandwidth may be performed based on any appropriate determination, such as a charging rate profile of the first network entity, a discharging rate profile of the first network entity, an energy state of the first network entity, a packet or application delay requirements, and a packet delay budget.

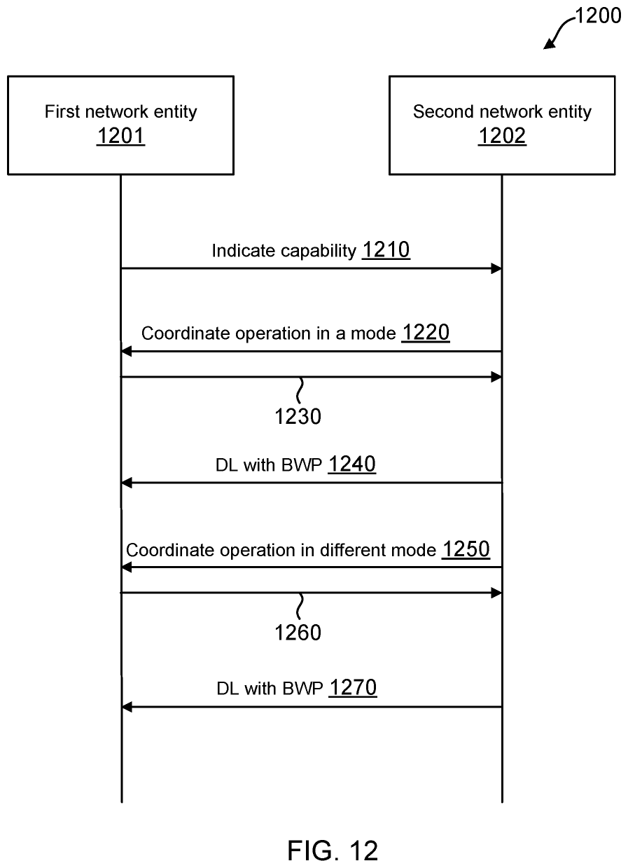

Various aspects include communication between the first network entity and the second network entity, where the first network entity informs the second network entity of its ability to operate in a mode in which it makes use of multiple instances of information. FIG. 12 is a signal diagram illustration of example communications between a first network entity 1201 (e.g., a UE) and a second network entity (e.g., a BS), according to some aspects of the present disclosure.

At action 1210, the first network entity 1201 may indicate its capabilities to the second network entity 1202. Capability reporting may include communications dynamically through L1/L2/L3 signaling (including user assistance information (UAI)) or multiplexed with one or more of L1/L2/L3 signaling (e.g., scheduling request, buffer status reporting, HARQ-ACK, power headroom report, RACH msg, etc), as a response to capability inquiry from the network, or the like.

Capability reporting may indicate an ability of the first network entity to operate in any one or more than one of the first mode, the second mode, the third mode, or the fourth mode as well as any additional modes (e.g., eRedCap, RedCap, eMBB, and the like).

At actions 1220, 1230, the first network entity 1201 and the second network entity 1202 may coordinate to operate in a particular mode. For instance, the first network entity 1201 and the second network entity 1202 may coordinate to operate in the first mode, the second mode, the third mode, or the fourth mode. As noted above, any one of those modes (first-fourth) may include the second network entity 1202 transmitting and the first network entity 1201 receiving a first instance of information on a first sub-band of a bandwidth part and a second instance of the information on a second sub-band of the bandwidth part, wherein the first instance of the information and the second instance of the information fully overlap in time. Action 1240 includes a DL transmission including a bandwidth part having the first-sub-band and the second-sub-band. An example is shown at FIG. 5, where bandwidth part 402 includes first instance of information 510 and second instance of information 520 within Slot n.

Actions 1250 and 1260 include the first network entity 1201 and the second network entity 1202 coordinating to operate in a different mode. For instance, the capability indication of action 1210 may have included an indication that the first network entity 1201 may switch between different modes. In one aspect, actions 1250, 1260 may include either the first network entity 1201 or the second network entity 1202 initiating a switch from the first mode (as described above) to a more energy-intensive and processing-intensive mode, such as eMBB. In such an example, action 1270 may include a DL transmission with a bandwidth part that does not include multiple instances of the same information in different sub-bands. In other words, in such an example, the DL transmission of action 1270 may not conform to the sub-band and information instance arrangement shown in FIG. 5. Of course, the switch between modes is not limited from switching from the first mode to a more energy intensive mode. Rather, the switch between modes may include a switch from any of the second mode, the third mode, or the fourth mode to a more energy intensive mode.

Of course, the scope of aspects is not limited to the operations shown in FIG. 12. Rather, further aspects may include the UE switching from the different mode, associated with actions 1250-1270) to yet another mode, such as the first mode, the second mode, the third mode, or the fourth mode. Switching between modes may go on and on as appropriate.

Moreover, the second network entity may also perform actions, such as illustrated in FIG. 12. Specifically, the second network entity (e.g., a BS) may communicate with the first network entity to receive an indication of the capabilities of the first network entity (action 1210). The second network entity may then, based on the capabilities of the first network entity and further coordination (action 1230), transmit a wireless communication to the first network entity (1240). The wireless communication may include a first instance of information on a first sub-band of a bandwidth part and a second instance of the information on a second sub-band of the bandwidth part, wherein the first instance of the information and the second instance of the information fully overlap in time, such as illustrated in FIG. 5. The second network entity may also coordinate changes (action 1260) from one mode of operation to another mode of operation by the first network entity, such as by initiating the mode change or by receiving an indication from the first network entity that the switch will take place.

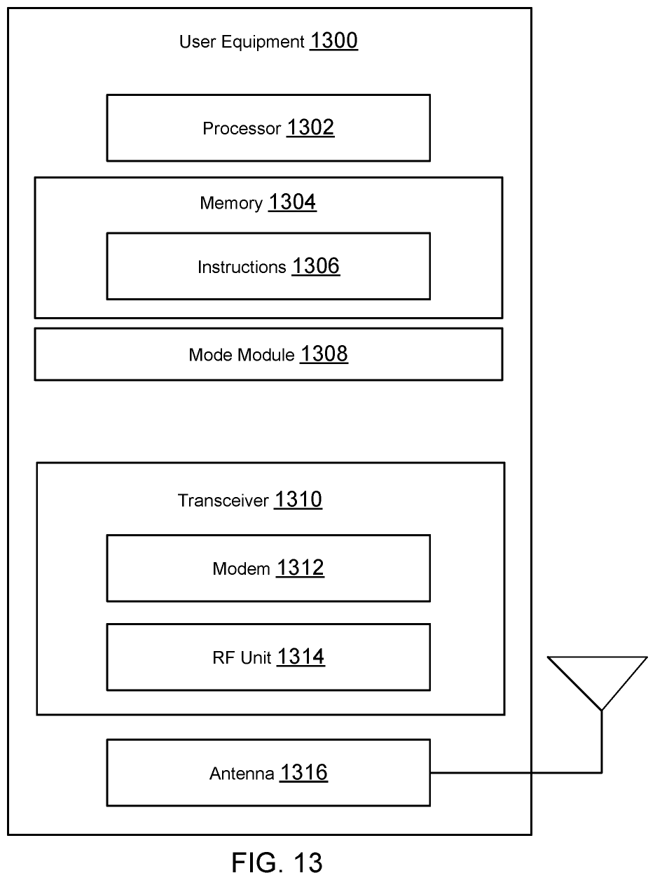

FIG. 13 is a block diagram of an exemplary UE 1300 according to some aspects of the present disclosure. The UE 1300 may be the UE 115 in the network 100, or architecture 200 as discussed above. As shown, the UE 1300 may include a processor 1302, a memory 1304, a mode module 1308, a transceiver 1310 including a modem subsystem 1312 and a radio frequency (RF) unit 1314, and one or more antennas 1316. These elements may be coupled with each other and in direct or indirect communication with each other, for example via one or more buses.

The processor 1302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 1304 includes a non-transitory computer-readable medium.

The memory 1304 may store instructions 1306. The instructions 1306 may include instructions that, when executed by the processor 1302, cause the processor 1302 to perform the operations described herein with reference to the UEs 115 in connection with aspects of the present disclosure, for example, aspects of FIGS. 6-12. Instructions 1306 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The mode module 1308 may be implemented via hardware, software, or combinations thereof. For example, the mode module 1308 may be implemented as a processor, circuit, and/or instructions 1306 stored in the memory 1304 and executed by the processor 1302. In some aspects, the mode module 1308 may implement the aspects of FIGS. 6-12.

As shown, the transceiver 1310 may include the modem subsystem 1312 and the RF unit 1314. The transceiver 1310 may be configured to communicate bi-directionally with other devices, such as the BSs 105 and/or the UEs 115. The modem subsystem 1312 may be configured to modulate and/or encode the data from the memory 1304 and the according to a modulation and coding scheme (MCS), e.g., a low-density parity check (LDPC) coding scheme, a turbo coding scheme, a convolutional coding scheme, a digital beamforming scheme, etc. The RF unit 1314 may be configured to process (e.g., perform analog to digital conversion or digital to analog conversion, etc.) modulated/encoded data from the modem subsystem 1312 (on outbound transmissions) or of transmissions originating from another source such as a UE 115 or a BS 105. The RF unit 1314 may be further configured to perform analog beamforming in conjunction with the digital beamforming. Although shown as integrated together in transceiver 1310, the modem subsystem 1312 and the RF unit 1314 may be separate devices that are coupled together to enable the UE 1300 to communicate with other devices.

The RF unit 1314 may provide the modulated and/or processed data, e.g. data packets (or, more generally, data messages that may contain one or more data packets and other information), to the antennas 1316 for transmission to one or more other devices. The antennas 1316 may further receive data messages transmitted from other devices. The antennas 1316 may provide the received data messages for processing and/or demodulation at the transceiver 1310. The antennas 1316 may include multiple antennas of similar or different designs in order to sustain multiple transmission links. The RF unit 1314 may configure the antennas 1316.

In some instances, the UE 1300 may include multiple transceivers 1310 implementing different RATs (e.g., NR and LTE). In some instances, the UE 1300 may include a single transceiver 1310 implementing multiple RATs (e.g., NR and LTE). In some instances, the transceiver 1310 may include various components, where different combinations of components may implement RATs.

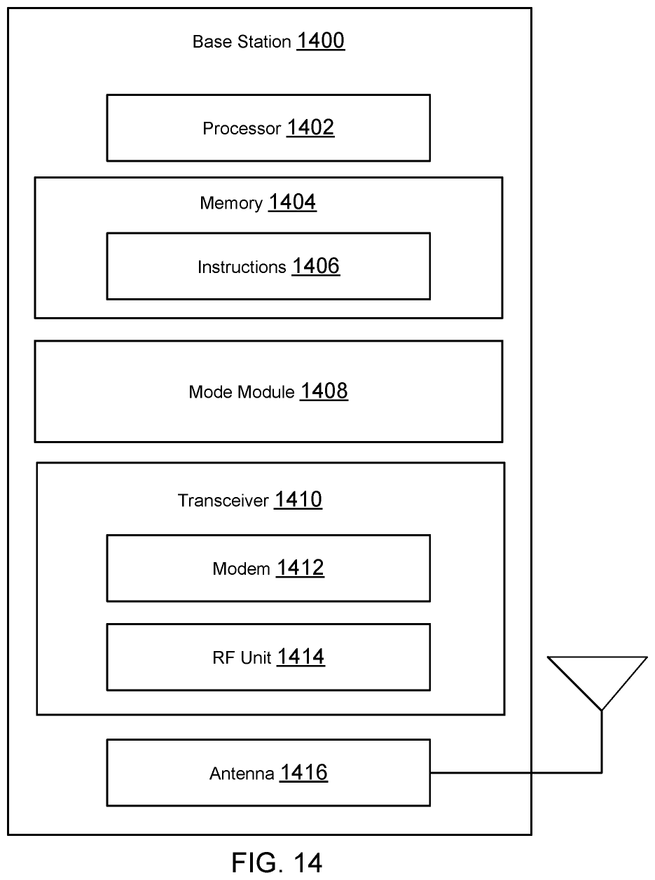

FIG. 14 is a block diagram of an exemplary network unit 1400 according to some aspects of the present disclosure. The network unit 1400 may be the BS 105, the CU 210, the DU 230, or the RU 240, as discussed above. As shown, the network unit 1400 may include a processor 1402, a memory 1404, a mode module 1408, a transceiver 1410 including a modem subsystem 1412 and a RF unit 1414, and one or more antennas 1416. These elements may be coupled with each other and in direct or indirect communication with each other, for example via one or more buses.

The processor 1402 may have various features as a specific-type processor. For example, these may include a CPU, a DSP, an ASIC, a controller, a FPGA device, another hardware device, a firmware device, or any combination thereof configured to perform the operations described herein. The processor 1402 may also be implemented as a combination of computing devices, e.g., a combination of a DSP and a microprocessor, a plurality of microprocessors, one or more microprocessors in conjunction with a DSP core, or any other such configuration.

The memory 1404 may include a cache memory (e.g., a cache memory of the processor 1402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1404 may include a non-transitory computer-readable medium.

The memory 1404 may store instructions 1406. The instructions 1406 may include instructions that, when executed by the processor 1402, cause the processor 1402 to perform operations described herein, for example, aspects of FIGS. 6-12. Instructions 1406 may also be referred to as code, which may be interpreted broadly to include any type of computer-readable statement(s).

The mode module 1408 may be implemented via hardware, software, or combinations thereof. In some aspects, the mode module 1408 may implement the aspects of FIGS. 6-12. For example, the mode module 1408 may communicate with the UE 115 or UE 1300 to facilitate the operation of the UE and one or more of the modes (described above), including switching between different modes, and including transmitting multiple instances of information overlapping in time, such as illustrated in FIG. 5.

Additionally or alternatively, the mode module 1408 may be implemented in any combination of hardware and software, and may, in some implementations, involve, for example, processor 1402, memory 1404, instructions 1406, transceiver 1410, and/or modem 1412.

As shown, the transceiver 1410 may include the modem subsystem 1412 and the RF unit 1414. The transceiver 1410 may be configured to communicate bi-directionally with other devices, such as the UEs 115 and/or UE 1300. The modem subsystem 1412 may be configured to modulate and/or encode data according to a MCS, e.g., a LDPC coding scheme, a turbo coding scheme, a convolutional coding scheme, a digital beamforming scheme, etc. The RF unit 1414 may be configured to process (e.g., perform analog to digital conversion or digital to analog conversion, etc.)

modulated/encoded data from the modem subsystem 1412 (on outbound transmissions) or of transmissions originating from another source such as a UE 115 or UE 1300. The RF unit 1414 may be further configured to perform analog beamforming in conjunction with the digital beamforming. Although shown as integrated together in transceiver 1410, the modem subsystem 1412 and/or the RF unit 1414 may be separate devices that are coupled together at the network unit 1400 to enable the network unit 1400 to communicate with other devices.

The RF unit 1414 may provide the modulated and/or processed data, e.g. data packets (or, more generally, data messages that may contain one or more data packets and other information), to the antennas 1416 for transmission to one or more other devices. This may include, for example, a configuration indicating a plurality of sub-slots within a slot according to aspects of the present disclosure. The antennas 1416 may further receive data messages transmitted from other devices and provide the received data messages for processing and/or demodulation at the transceiver 1410. The antennas 1416 may include multiple antennas of similar or different designs in order to sustain multiple transmission links.

In some instances, the network unit 1400 may include multiple transceivers 1410 implementing different RATs (e.g., NR and LTE). In some instances, the network unit 1400 may include a single transceiver 1410 implementing multiple RATs (e.g., NR and LTE). In some instances, the transceiver 1410 may include various components, where different combinations of components may implement RATs.

Further aspects of the present disclosure include the following clauses:

1. A first network entity comprising:
at least one memory;
at least one transceiver; and
at least one processor coupled to the at least one memory and the at least one transceiver, wherein the first network entity is configured to:
receive, from a second network entity, a first instance of information on a first sub-band of a bandwidth part and a second instance of the information on a second sub-band of the bandwidth part, wherein the first instance of the information and the second instance of the information fully overlap in time; and operate in a mode, wherein:
the mode is a first mode in which the first network entity is configured to: filter the first instance of the information to generate first sub-band information and filter the second instance of the information to generate second sub-band information; generate, based on combining information including an amplitude parameter and a phase parameter, an analog combination of the first sub-band information and the second sub-band information, wherein the analog combination is a weighted sum of the first sub-band information and the second sub-band information; and process the analog combination;
the mode is a second mode in which the first network entity is configured to: convert the first instance of the information on the first sub-band to baseband and separately convert the second instance of the information on the second sub-band to baseband; sample the first instance of the information at baseband to generate first sampled information and sample the second instance of the information at baseband to generate second sampled information; process the first sampled information according to a first timeline; and process the second sampled information according to a second timeline;
the mode is a third mode in which the first network entity is configured to: simultaneously convert the first instance of the information on the first sub-band and the second instance of the information on the second sub-band together to baseband; sample the first instance of the information and the second instance of the information together at baseband to generate third sampled information, wherein a first portion of the third sampled information corresponds to the first instance of the information, and wherein a second portion of the third sampled information corresponds to the second instance of the information; process the first portion according to a third timeline; and process the second portion according to a fourth timeline; or
the mode is a fourth mode in which the first network entity is configured to: process data associated with the first instance of the information; and perform energy harvesting on the second instance of the information.

2. The first network entity of clause 1, wherein the mode is the first mode, and wherein the first network entity is configured to receive the combining information from the second network entity.

3. The first network entity of any of clauses 1-2, wherein the mode is the first mode, and wherein the first instance of the information and the second instance of the information have a same redundancy version.

4. The first network entity of any of clauses 1-3, wherein the mode is the first mode, wherein, to process the analog combination, the first network entity is configured to perform a decoding operation on the analog combination.

5. The first network entity of any of clauses 1-4, wherein the first instance of the information is a transport block (TB) for a physical downlink shared channel (PDSCH) and the second instance of the information is the TB for the PDSCH, and wherein the first instance of the information and the second instance of information have a same redundancy version.

6. The first network entity of any of clauses 1-5, wherein the first instance of the information corresponds to a maximum baseband bandwidth capability of a modem associated with the at least one transceiver, and wherein the second instance of the information corresponds to the maximum baseband bandwidth capability of the modem.

7. The first network entity of any of clauses 1-6, wherein the first network entity is configured to indicate its capability to operate in the first mode to the second network entity.

8. The first network entity of clause 1, wherein the mode is the second mode, wherein, to process the first sampled information according to the first timeline, the first network entity is configured to perform a decoding operation on the first sampled information, and wherein the first network entity is configured to perform a decoding operation on the second sampled information based on a failure of the decoding operation on the first sampled information.

9. The first network entity of clause 1, wherein the mode is the second mode, and wherein to process the first sampled information according to the first timeline, the first network entity is configured to:
combine a first log likelihood ratio (LLR) of the first sampled information with a second LLR of the second sampled information to generate combined sampled information; and
process the combined sampled information.

10. The first network entity of clause 1, wherein the mode is the second mode, and wherein to process the first sampled information according to the first timeline, the first network entity is configured to perform CSI reporting for the first sub-band, and wherein to process the second sampled information according to the second timeline the first network entity is configured to perform CSI reporting for the second sub-band.

11. The first network entity of clause 1, wherein the first network entity is configured to:
receive, from the second network entity, a first downlink (DL)-positioning reference signal (PRS) on the first sub-band;
receive, from the second network entity, a second DL-PRS on the first sub-band; and
transmit report information to the second entity, wherein the report information is based on the first DL-PRS and the second DL-PRS.

12. The first network entity of clause 11, wherein the report information includes information indicative of the first DL-PRS and information indicative of the second DL-PRS.

13. The first network entity of clause 12, wherein the information indicative of the first DL-PRS includes first position-related information associated with the first DL-PRS or a first reference signal received power (RSRP), and wherein the information indicative of the second DL-PRS includes second position-related information associated with the second DL-PRS or a second RSRP.

14. The first network entity of clause 11, wherein the first DL-PRS is a first channel state information (CSI)-reference signal (RS), and the second DL-PRS is a second CSI-RS.

15. The first network entity of clause 11, wherein the first network entity is configured to generate the report information based on the first DL-PRS and the second DL-PRS.

16. The first network entity of clause 11, wherein the first network entity is configured to adjust first information based on the first DL-PRS and the second DL-PRS to generate adjusted first information.

17. The first network entity of clause 16, wherein the report information includes the adjusted first information.

18. The first network entity of clause 17, wherein the first information is position-related information.

19. The first network entity of clause 1, wherein the first network entity is configured to indicate its capability to operate in the second mode to the second network entity.

20. The first network entity of clause 1, wherein the mode is the third mode, and wherein to sample the first instance of the information and the second instance of the information, the first network entity is configured to oversample an entirety of the bandwidth part based on a sampling rate of X multiplied by a bandwidth associated with the first sub-band and the second sub-band, wherein X is a number larger than one.

21. The first network entity of any of clauses 1 and 20, wherein the first network entity is configured to determine that a quantity of available resources is above a first threshold and that a reliability requirement for reception is above a second threshold, and wherein, to operate in the mode, the first network entity is configured to operate in the third mode based on the determination.

22. The first network entity of clause 21, wherein the first threshold is with respect to timing, and wherein the second threshold is with respect to channel state information.

23. The first network entity of any of clauses 1 and 20, wherein the mode is the third mode, and wherein the first network entity is configured to store the third sampled information in a memory space of the at least one memory, and wherein to process the first portion, the first network entity is configured to read the first portion from the at least one memory.

24. The first network entity of any of clauses 1-23, wherein the first network entity is configured to indicate, to the second network entity, a capability to switch between one of the first mode, the second mode, the third mode, or the fourth mode and a further mode of operation including greater bandwidth use and power use than any of the first mode, the second mode, the third mode, or the fourth mode.

25. The first network entity of clause 24, wherein the further mode of operation includes at least one of:
Enhanced Mobile Broadband (eMBB);
Ultra-Reliable Low Latency Communications (URLLC)
Narrowband Internet of Things (NB-IoT); or
Ambient IoT.

26. The first network entity of clause 24, wherein the first network entity is configured to switch from one of the first mode, the second mode, or the third mode to the further mode of operation based on measurement of one or more of: energy availability at the first network entity, data traffic type, priority of data traffic, or quality of service requirements applicable to data traffic.

27. The first network entity of clause 1, wherein the first network entity is configured to receive instruction from the second network entity to operate in the fourth mode.

28. The first network entity of clause 1, wherein the first network entity is configured to operate in the fourth mode based on at least one of: data reliability information, delay requirement information, or energy information.

29. The first network entity of clause 1, wherein the mode is the fourth mode, and wherein the first network entity is configured to:
receive information indicative of a quantity of resources; and
select, based on the information indicative of the quantity of resources, the quantity of resources from the first instance of the information and the second instance of the information for energy harvesting.

30. The first network entity of clause 1, wherein the mode is the fourth mode, and wherein the first network entity is configured to:
temporarily increase a maximum baseband bandwidth capability of the first network entity on a time period-to-time period basis for received data based on at least one of: a charging rate profile of the first network entity, a discharging rate profile of the first network entity, an energy state of the first network entity, a packet or application delay requirements, or a packet delay budget.

31. The first network entity of any of clauses 1-30, wherein the first instance of the information is located in one or more symbols and the second instance of the information is located in the one or more symbols.

32. The first network entity of any of clauses 1-31, wherein the information includes at least one of: a reference signal, a transport block (TB) of a physical downlink shared channel (PDSCH), a physical downlink control channel (PDCCH) signal, a synchronization signal block (SSB), or a downlink random access channel (RACH) message.

33. The first network entity of clause 1, wherein the mode is the second mode, and the first network entity is configured store the first sampled information in a first memory space in the at least one memory and store the second sampled information in a second memory space in the at least one memory.

34. The first network entity of clause 33, wherein the first memory space is a first buffer and the second memory space is a second buffer.

35. The first network entity of any of clauses 1-34, wherein the first network entity is a reduced capacity (RedCap) device, an enhanced reduced capability (eRedCap) device, an ambient internet-of-things (IoT) device, or an energy harvesting (EH)-capable device.

36. The first network entity of any of clauses 1-35, wherein the analog combination is a radio frequency combination.

37. A first network entity comprising:
at least one memory;
at least one transceiver; and
at least one processor coupled to the at least one memory and the at least one transceiver, wherein the first network entity is configured to:
receive an indication, from a second network entity on an uplink (UL) transmission, of a capability of the second network entity to operate in a mode in which the second network entity acts with respect to multiple instances of data or multiple instances of a signal within a bandwidth part and overlapping in a time domain; and
transmit, based on the indication, on a downlink (DL) transmission a first instance of information on a first sub-band and a second instance of the information on a second sub-band, wherein the first instance of the information and the second instance of the information fully overlap in the time domain.

38. The first network entity of clause 37, wherein the first network entity is a base station, and wherein the second network entity is a user equipment, and wherein the first network entity is further configured to: coordinate with the second network entity to switch from a first mode of operation to a second mode of operation, wherein the first mode of operation includes the first instance of the information and the second instance of the information, and wherein the second mode of operation does not include the second network entity being configured to act with respect to multiple instances of data or multiple instances of a signal within the bandwidth part.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations may be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

As described herein, a node (which may be referred to as a node, a network node, a network entity, or a wireless node) may include, be, or be included in (e.g., be a component of) a base station (e.g., any base station described herein), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

What is claimed is:

1. A first network entity comprising:
at least one memory;
at least one transceiver; and
at least one processor coupled to the at least one memory and the at least one transceiver, wherein the first network entity is configured to:
receive, from a second network entity, a first instance of information on a first sub-band of a bandwidth part and a second instance of the information on a second sub-band of the bandwidth part, wherein the first instance of the information and the second instance of the information fully overlap in time; and
operate in a mode, wherein:
the mode is a first mode in which the first network entity is configured to: filter the first instance of the information to generate first sub-band information and filter the second instance of the information to generate second sub-band information; generate, based on combining information including an amplitude parameter and a phase parameter, an analog combination of the first sub-band information and the second sub-band information, wherein the analog combination is a weighted sum of the first sub-band information and the second sub-band information; and process the analog combination;
the mode is a second mode in which the first network entity is configured to: convert the first instance of the information on the first sub-band to baseband and separately convert the second instance of the information on the second sub-band to baseband; sample the first instance of the information at baseband to generate first sampled information and sample the second instance of the information at baseband to generate second sampled information; process the first sampled information according to a first timeline; and process the second sampled information according to a second timeline;
the mode is a third mode in which the first network entity is configured to: simultaneously convert the first instance of the information on the first sub-band and the second instance of the information on the second sub-band together to baseband; sample the first instance of the information and the second instance of the information together at baseband to generate third sampled information, wherein a first portion of the third sampled information corresponds to the first instance of the information, and wherein a second portion of the third sampled information corresponds to the second instance of the information; process the first portion according to a third timeline; and process the second portion according to a fourth timeline; or
the mode is a fourth mode in which the first network entity is configured to: process data associated with the first instance of the information; and perform energy harvesting on the second instance of the information.

2. The first network entity of claim 1, wherein the mode is the first mode, and wherein the first network entity is configured to receive the combining information from the second network entity.

3. The first network entity of claim 1, wherein the mode is the first mode, and wherein the first instance of the information and the second instance of the information have a same redundancy version.

4. The first network entity of claim 1, wherein the mode is the first mode, wherein, to process the analog combination, the first network entity is configured to perform a decoding operation on the analog combination.

5. The first network entity of claim 1, wherein the first instance of the information is a transport block (TB) for a physical downlink shared channel (PDSCH) and the second instance of the information is the TB for the PDSCH, and wherein the first instance of the information and the second instance of information have a same redundancy version.

6. The first network entity of claim 1, wherein the first instance of the information corresponds to a maximum baseband bandwidth capability of a modem associated with the at least one transceiver, and wherein the second instance of the information corresponds to the maximum baseband bandwidth capability of the modem.

7. The first network entity of claim 1, wherein the first network entity is configured to indicate its capability to operate in the first mode to the second network entity.

8. The first network entity of claim 1, wherein the mode is the second mode, wherein, to process the first sampled information according to the first timeline, the first network entity is configured to perform a decoding operation on the first sampled information, and
wherein the first network entity is configured to perform a decoding operation on the second sampled information based on a failure of the decoding operation on the first sampled information.

9. The first network entity of claim 1, wherein the mode is the second mode, and wherein to process the first sampled information according to the first timeline, the first network entity is configured to:
combine a first log likelihood ratio (LLR) of the first sampled information with a second LLR of the second sampled information to generate combined sampled information; and
process the combined sampled information.

10. The first network entity of claim 1, wherein the mode is the second mode, and wherein to process the first sampled information according to the first timeline, the first network entity is configured to perform CSI reporting for the first sub-band, and wherein to process the second sampled information according to the second timeline the first network entity is configured to perform CSI reporting for the second sub-band.

11. The first network entity of claim 1, wherein the first network entity is configured to:
receive, from the second network entity, a first downlink (DL)-positioning reference signal (PRS) on the first sub-band;
receive, from the second network entity, a second DL-PRS on the first sub-band; and
transmit report information to the second entity, wherein the report information is based on the first DL-PRS and the second DL-PRS.

12. The first network entity of claim 11, wherein the report information includes information indicative of the first DL-PRS and information indicative of the second DL-PRS.

13. The first network entity of claim 12, wherein the information indicative of the first DL-PRS includes first position-related information associated with the first DL-PRS or a first reference signal received power (RSRP), and wherein the information indicative of the second DL-PRS includes second position-related information associated with the second DL-PRS or a second RSRP.

14. The first network entity of claim 11, wherein the first DL-PRS is a first channel state information (CSI)-reference signal (RS), and the second DL-PRS is a second CSI-RS.

15. The first network entity of claim 11, wherein the first network entity is configured to generate the report information based on the first DL-PRS and the second DL-PRS.

16. The first network entity of claim 11, wherein the first network entity is configured to adjust first information based on the first DL-PRS and the second DL-PRS to generate adjusted first information.

17. The first network entity of claim 16, wherein the report information includes the adjusted first information.

18. The first network entity of claim 17, wherein the first information is position-related information.

19. The first network entity of claim 1, wherein the first network entity is configured to indicate its capability to operate in the second mode to the second network entity.

20. The first network entity of claim 1, wherein the mode is the third mode, and wherein to sample the first instance of the information and the second instance of the information, the first network entity is configured to oversample an entirety of the bandwidth part based on a sampling rate of X multiplied by a bandwidth associated with the first sub-band and the second sub-band, wherein X is a number larger than one.

21. The first network entity of claim 1, wherein the first network entity is configured to determine that a quantity of available resources is above a first threshold and that a reliability requirement for reception is above a second threshold, and wherein, to operate in the mode, the first network entity is configured to operate in the third mode based on the determination.

22. The first network entity of claim 21, wherein the first threshold is with respect to timing, and wherein the second threshold is with respect to channel state information.

23. The first network entity of claim 1, wherein the mode is the third mode, and wherein the first network entity is configured to store the third sampled information in a memory space of the at least one memory, and wherein to process the first portion, the first network entity is configured to read the first portion from the at least one memory.

24. The first network entity of claim 1, wherein the first network entity is configured to indicate, to the second network entity, a capability to switch between one of the first mode, the second mode, the third mode, or the fourth mode and a further mode of operation including greater bandwidth use and power use than any of the first mode, the second mode, the third mode, or the fourth mode.

25. The first network entity of claim 24, wherein the further mode of operation includes at least one of:
Enhanced Mobile Broadband (eMBB);
Ultra-Reliable Low Latency Communications (URLLC)
Narrowband Internet of Things (NB-IoT); or
Ambient IoT.

26. The first network entity of claim 24, wherein the first network entity is configured to switch from one of the first mode, the second mode, or the third mode to the further mode of operation based on measurement of one or more of: energy availability at the first network entity, data traffic type, priority of data traffic, or quality of service requirements applicable to data traffic.

27. The first network entity of claim 1, wherein the first network entity is configured to receive instruction from the second network entity to operate in the fourth mode.

28. The first network entity of claim 1, wherein the first network entity is configured to operate in the fourth mode based on at least one of: data reliability information, delay requirement information, or energy information.

29. The first network entity of claim 1, wherein the mode is the fourth mode, and wherein the first network entity is configured to:
receive information indicative of a quantity of resources; and
select, based on the information indicative of the quantity of resources, the quantity of resources from the first instance of the information and the second instance of the information for energy harvesting.

30. The first network entity of claim 1, wherein the mode is the fourth mode, and wherein the first network entity is configured to:
temporarily increase a maximum baseband bandwidth capability of the first network entity on a time period-to-time period basis for received data based on at least one of: a charging rate profile of the first network entity, a discharging rate profile of the first network entity, an energy state of the first network entity, a packet or application delay requirements, or a packet delay budget.

31. The first network entity of claim 1, wherein the first instance of the information is located in one or more symbols and the second instance of the information is located in the one or more symbols.

32. The first network entity of claim 1, wherein the information includes at least one of: a reference signal, a transport block (TB) of a physical downlink shared channel (PDSCH), a physical downlink control channel (PDCCH) signal, a synchronization signal block (SSB), or a downlink random access channel (RACH) message.

33. The first network entity of claim 1, wherein the mode is the second mode, and the first network entity is configured store the first sampled information in a first memory space in the at least one memory and store the second sampled information in a second memory space in the at least one memory.

34. The first network entity of claim 33, wherein the first memory space is a first buffer and the second memory space is a second buffer.

35. The first network entity of claim 1, wherein the first network entity is a reduced capacity (RedCap) device, an enhanced reduced capability (eRedCap) device, an ambient internet-of-things (IoT) device, or an energy harvesting (EH)-capable device.

36. The first network entity of claim 1, wherein the analog combination is a radio frequency combination.

37. A first network entity comprising:
at least one memory;
at least one transceiver; and
at least one processor coupled to the at least one memory and the at least one transceiver, wherein the first network entity is configured to:
receive an indication, from a second network entity on an uplink (UL) transmission, of a capability of the second network entity to operate in a mode in which the second network entity acts with respect to multiple instances of data or multiple instances of a signal within a bandwidth part and overlapping in a time domain; and
transmit, based on the indication, on a downlink (DL) transmission a first instance of information on a first sub-band and a second instance of the information on a second sub-band, wherein the first instance of the information and the second instance of the information fully overlap in the time domain.

38. The first network entity of claim 37, wherein the first network entity is a base station, and wherein the second network entity is a user equipment, and
wherein the first network entity is further configured to: coordinate with the second network entity to switch from a first mode of operation to a second mode of operation, wherein the first mode of operation includes the first instance of the information and the second instance of the information, and wherein the second mode of operation does not include the second network entity being configured to act with respect to multiple instances of data or multiple instances of a signal within the bandwidth part.
